(19) United States
(12) Patent Application Publication
(10) Pub. No.: US 2007/0173597 A1
(43) Pub. Date: Jul. 26, 2007

(54) Sealant composition containing inorganic-organic nanocomposite filler

(76) Inventors: David A. Williams, Gansevoort, NY (US); Vikram Kumar, Bangalore (IN); Edward J. Nesakumar, Bangalore (IN); Indumathi Ramakrishnan, Bangalore (IN)

Correspondence Address: DILWORTH & BARRESE, LLP, 333 EARLE OVINGTON BLVD., SUITE 702, UNIONDALE, NY, 11553, US

(21) Appl. No.: 11/336,760

(22) Filed: Jan. 20, 2006

(51) Int. Cl. C08L 83/04

(52) U.S. Cl. 524/588; 528/18; 528/34; 524/442; 525/100; 525/105; 525/106; 525/444

(57) ABSTRACT

This invention relates to a room temperature curable composition containing, inter alia, diorganopolysiloxane(s) and inorganic-organic nanocomposite(s), the cured composition exhibiting low permeability to gas(es).

### FIELD OF THE INVENTION

This invention relates to a room temperature curable composition exhibiting, when cured, low permeability to gas(es).

### BACKGROUND OF THE INVENTION

Room temperature curable (RTC) compositions are well known for their use as sealants. In the manufacture of Insulating Glass Units (IGU), for example, panels of glass are placed parallel to each other and sealed at their periphery such that the space between the panels, or the inner space, is completely enclosed. The inner space is typically filled with a gas or mixture of gases of low thermal conductivity, e.g. argon. Current room temperature curable silicone sealant compositions, while effective to some extent, still have only a limited ability to prevent the loss of insulating gas from the inner space of an IGU. Over time, the gas will escape reducing the thermal insulation effectiveness of the IGU to the vanishing point.

The addition of clay materials to polymers is known in the art, however, incorporating clays into polymers may not provide a desirable improvement in the physical properties, particularly mechanical properties, of the polymer. This may be due, for example, to the lack of affinity between the clay and the polymer at the interface, or the boundary, between the clay and polymer within the material. The affinity between the clay and the polymer may improve the physical properties of the resulting nanocomposite by allowing the clay material to uniformly disperse throughout the polymer. The relatively large surface area of the clay, if uniformly dispersed, may provide more interfaces between the clay and polymer, and may subsequently improve the physical properties, by reducing the mobility of the polymer chains at these interfaces. By contrast, a lack of affinity between the clay and polymer may adversely affect the strength and uniformity of the composition by having pockets of clay concentrated, rather than uniformly dispersed, throughout the polymer. Affinity between clays and polymers is related to the fact that clays, by nature, are generally hydrophilic whereas polymers are generally hydrophobic.

A need therefore exists for an RTC composition of reduced gas permeability compared to that of known RTC compositions. When employed as the sealant for an IGU, an RTC composition of reduced gas permeability will retain the intra-panel insulating gas for a longer period of time compared to that of a more permeable RTC composition and will therefore extend the insulating properties of the IGU over a longer period of time.

### SUMMARY OF THE INVENTION

The present invention is based on the discovery that curable silanol-terminated diorganopolysiloxane combined with filler of a certain type upon curing exhibits reduced permeability to gas. The composition is especially suitable for use as a sealant where high gas barrier properties together with the desired characteristics of softness, processability and elasticity are important performance criteria.

In accordance with the present invention, there is provided a curable composition comprising:
a) at least one silanol-terminated diorganopolysiloxane;
b) at least one crosslinker for the silanol-terminated diorganopolysiloxane(s);
c) at least one catalyst for the crosslinking reaction;
d) a gas barrier enhancing amount of at least one inorganic-organic nanocomposite; and, optionally,
e) at least one solid polymer having a permeability to gas that is less than the permeability of the crosslinked diorganopolysiloxane(s).

When used as a gas barrier, e.g., in the manufacture of an IGU, the foregoing composition reduces the loss of gas(es) thus providing a longer service life of the article in which it is employed.

### BRIEF DESCRIPTION OF THE DRAWINGS

FIG. 1 is a graphic presentation of permeability data for the sealant compositions of Comparative Example 1 and Examples 1 and 2.

FIG. 2 is a graphic presentation of permeability data for the sealant compositions of Comparative Example 2 and Example 3.

FIG. 3 is a graphic presentation of permeability data for the sealant compositions of Comparative Example 3 and Examples 4 and 5.

### DETAILED DESCRIPTION OF THE INVENTION

The curable sealant composition of the present invention is obtained by mixing a) at least one silanol-terminated diorganopolysiloxane; b) at least one crosslinker for the silanol-terminated diorganopolysiloxane(s); c) at least one catalyst for the crosslinking reaction; d) a gas barrier enhancing amount of at least one inorganic-organic nanocomposite; and, optionally, e) at least one solid polymer having a permeability to gas that is less than the permeability of the crosslinked diorganopolysiloxane(s), the composition following curing exhibiting low permeability to gas(es).

The compositions of the invention are useful for the manufacture of sealants, coatings, adhesives, gaskets, and the like, and are particularly suitable for use in sealants intended for insulating glass units.

When describing the invention, the following terms have the following meanings, unless otherwise indicated.

Definitions

The term “exfoliation” as used herein describes a process wherein packets of nanoclay platelets separate from one another in a polymer matrix. During exfoliation, platelets at the outermost region of each packet cleave off, exposing more platelets for separation.

The term “gallery” as used herein describes the space between parallel layers of clay platelets. The gallery spacing changes depending on the nature of the molecule or polymer occupying the space. An interlayer space between individual nanoclay platelets varies, again depending on the type of molecules that occupy the space.

The term “intercalant” as used herein includes any inorganic or organic compound capable of entering the clay gallery and bonding to its surface.

The term “intercalate” as used herein designates a clay-chemical complex wherein the clay gallery spacing has increased due to the process of surface modification. Under the proper conditions of temperature and shear, an intercalate is capable of exfoliating in a resin matrix.

As used herein, the term “intercalation” refers to a process for forming an intercalate.

The expression “inorganic nanoparticulate” as used herein describes layered inorganic material, e.g., clay, with one or more dimensions, such as length, width or thickness, in the nanometer size range and which is capable of undergoing ion exchange.

The expression “low permeability to gas(es)” as applied to the cured composition of this invention shall be understood to mean an argon permeability coefficient of not greater than about 900 barrers (1 barrer=10⁻¹⁰ (STP)/cm sec(cmHg)) measured in accordance with the constant pressure variable-volume method at a pressure of 100 psi and temperature of 25° C.

The expression “modified clay” as used herein designates a clay material, e.g., nanoclay, which has been treated with any inorganic or organic compound that is capable of undergoing ion exchange reactions with the cations present at the interlayer surfaces of the clay.

The term “nanoclay” as used herein describes clay materials that possess a unique morphology with one dimension being in the nanometer range. Nanoclays can form chemical complexes with an intercalant that ionically bonds to surfaces in between the layers making up the clay particles. This association of intercalant and clay particles results in a material which is compatible with many different kinds of host resins permitting the clay filler to disperse therein.

As used herein, the term “nanoparticulate” refers to particle sizes, generally determined by diameter, less than about 1000 nm.

As used herein, the term “platelets” refers to individual layers of the layered material.

The curable composition of the present invention includes at least one silanol-terminated diorganopolysiloxanes (a). Suitable silanol-terminated diorganopolysiloxanes (a) include those of the general formula:
MₐD_{b}D′_{c}
wherein “a” is 2, and “b” is equal to or greater than 1 and “c” is zero or positive; M is
(HO)_{3-x-y}R¹ₓR²_{y}SiO_{1/2}
wherein “x” is 0, 1 or 2 and “y” is either 0 or 1, subject to the limitation that x+y is less than or is equal to 2, R¹ and R² each independently is a monovalent hydrocarbon group up to 60 carbon atoms; D is
R³R⁴SiO_{1/2};
wherein R³ and R⁴ each independently is a monovalent hydrocarbon group up to 60 carbon atoms; and D is
R⁵R⁶SiO_{2/2}
wherein R⁵ and R⁶ each independently is a monovalent hydrocarbon group up to 60 carbon atoms.

Suitable crosslinkers (b) for the silanol-terminated diorganopolysiloxane(s) present in the composition of the invention include alkylsilicates of the general formula:
(R¹⁴O)(R¹⁵O)(R¹⁶O)(R¹⁷O)Si
wherein R¹⁴, R¹⁵, R¹⁶ and R¹⁷ each independently is a monovalent hydrocarbon group up to 60 carbon atoms. Crosslinkers of this type include, n-propyl silicate, tetraethylortho silicate and methyltrimethoxysilane and similar alkyl-substituted alkoxysilane compounds, and the like.

Suitable catalysts (c) for the crosslinking reaction of the silanol-terminated diorganopolysiloxane(s) can be any of those known to be useful for facilitating the crosslinking of such siloxanes. The catalyst can be a metal-containing or non-metallic compound. Examples of useful metal-containing compounds include those of tin, titanium, zirconium, lead, iron cobalt, antimony, manganese, bismuth and zinc.

In one embodiment of the present invention, tin-containing compounds useful as crosslinking catalysts include: dibutyltindilaurate, dibutyltindiacetate, dibutyltindimethoxide, tinoctoate, isobutyltintriceroate, dibutyltinoxide, soluble dibutyl tin oxide, dibutyltin bis-diisooctylphthalate, bis-tripropoxysilyl dioctyltin, dibutyltin bis-acetylacetone, silylated dibutyltin dioxide, carbomethoxyphenyl tin tris-uberate, isobutyltin triceroate, dimethyltin dibutyrate, dimethyltin di-neodecanoate, triethyltin tartarate, dibutyltin dibenzoate, tin oleate, tin naphthenate, butyltintri-2-ethylhexylhexoate, tinbutyrate, diorganotin bis β-diketonates, and the like. Useful titanium-containing catalysts include: chelated titanium compounds, e.g., 1,3-propanedioxytitanium bis(ethylacetoacetate), di-isopropoxytitanium bis(ethylacetoacetate), and tetraalkyl titanates, e.g., tetra n-butyl titanate and tetra-isopropyl titanate. In yet another embodiment of the present invention, diorganotin bis β-diketonates is used for facilitating crosslinking in silicone sealant composition.

Inorganic-organic nanocomposite (d) of the present invention is comprised of at least one inorganic component which is a layered inorganic nanoparticulate and at least one organic component which is a quaternary ammonium organopolysiloxane.

The inorganic nanoparticulate of the present invention can be natural or synthetic such as smectite clay, and should have certain ion exchange properties as in smectite clays, rectorite, vermiculite, illite, micas and their synthetic analogs, including laponite, synthetic mica-montmorillonite and tetrasilicic mica.

The nanoparticulates can possess an average maximum lateral dimension (width) in a first embodiment of between about 0.01 μm and about 10 μm, in a second embodiment between about 0.05 μm and about 2 μm, and in a third embodiment between about 0.1 μm and about 1 μm. The average maximum vertical dimension (thickness) of the nanoparticulates can in general vary in a first embodiment between about 0.5 nm and about 10 nm and in a second embodiment between about 1 nm and about 5 nm.

Useful inorganic nanoparticulate materials of the invention include natural or synthetic phyllosilicates, particularly smectic clays such as montmorillonite, sodium montmorillonite, calcium montmorillonite, magnesium montmorillonite, nontronite, beidellite, volkonskoite, laponite, hectorite, saponite, sauconite, magadite, kenyaite, sobockite, svindordite, stevensite, talc, mica, kaolinite, vermiculite, halloysite, aluminate oxides, or hydrotalcites, micaceous minerals such as illite and mixed layered illite/smectite minerals such as rectorite, tarosovite, ledikite and admixtures of illites with one or more of the clay minerals named above. Any swellable layered material that sufficiently sorbs the organic molecules to increase the interlayer spacing between adjacent phyllosilicate platelets to at least about 5 angstroms, or to at least about 10 angstroms, (when the phyllosilicate is measured dry) can be used in producing the inorganic-organic nanocomposite of the invention.

The modified inorganic nanoparticulate of the invention is obtained by contacting quantities of layered inorganic particulate possessing exchangeable cation, e.g., Na⁺, Ca²⁺, Al³⁺, Fe²⁺, Fe³⁺, and Mg²⁺, with at least one ammonium-containing organopolysiloxane. The resulting modified particulate is inorganic-organic nanocomposite (d) possessing intercalated organopolysiloxane ammonium ions.

The ammonium-containing organopolysiloxane must contain at least one ammonium group and can contain two or more ammonium groups. The quaternary ammonium groups can be position at the terminal ends of the organopolysiloxane and/or along the siloxane backbone. One class of useful ammonium-containing organopolysiloxane has the general formula:
MₐD_{b}D′_{c}
wherein “a” is 2, and “b” is equal to or greater than 1 and “c” is zero or positive; M is
[R³_{z}NR⁴]_{3-x-y}R¹ₓR²_{y}SiO_{1/2}
wherein “x” is 0, 1 or 2 and “y” is either 0 or 1, subject to the limitation that x+y is less than or equal to 2, “z” is 2, R¹ and R² each independently is a monovalent hydrocarbon group up to 60 carbons; R³ is selected from the group consisting of H and a monovalent hydrocarbon group up to 60 carbons; R⁴ is a monovalent hydrocarbon group up to 60 carbons; D is
R⁵R⁶SiO_{1/2}
where R⁵ and R⁶ each independently is a monovalent hydrocarbon group up to 60 carbon atoms; and D′ is
R⁷R⁸SiO_{2/2}
where R⁷ and R⁸ each independently is a monovalent hydrocarbon group containing amine with the general formula:
[R⁹ₐNR¹⁰]
wherein “a” is 2, R⁹ is selected from the group consisting of H and a monovalent hydrocarbon group up to 60 carbons; R¹⁰ is a monovalent hydrocarbon group up to 60 carbons.

In another embodiment of the present invention, the ammonium-containing organopolysiloxane is R¹¹R¹²R¹³N, wherein R¹¹, R¹², and R¹³ each independently is an alkoxy silane or a monovalent hydrocarbon group up to 60 carbons. The general formula for the alkoxy silane is
[R¹⁴O]_{3-x-y}R¹⁵ₓR¹⁶_{y}SiR¹⁷
wherein “x” is 0, 1 or 2 and “y” is either 0 or 1, subject to the limitation that x+y is less than or equal to 2; R¹⁴ is a monovalent hydrocarbon group up to 30 carbons; R¹⁵ and R¹⁶ are independently chosen monovalent hydrocarbon groups up to 60 carbons; R¹⁷ is a monovalent hydrocarbon group up to 60 carbons. Additional compounds useful for modifying the inorganic component of the present invention are amine compounds or the corresponding ammonium ion with the structure R¹⁸, R¹⁹ R²⁰N, wherein R¹⁸, R¹⁹, and R²⁰ each independently is an alkyl or alkenyl group of up to 30 carbon atoms, and each independently is an alkyl or alkenyl group of up to 20 carbon atoms in another embodiment, which may be the same or different. In yet another embodiment, the organic molecule is a long chain tertiary amine where R¹⁸, R¹⁹ and R²⁰ each independently is a 14 carbon to 20 carbon alkyl or alkenyl.

The layered inorganic nanoparticulate compositions of the present invention need not be converted to a proton exchange form. Typically, the intercalation of an organopolysiloxane ammonium ion into the layered inorganic nanoparticulate material is achieved by cation exchange using solvent and solvent-free processes. In the solvent-based process, the organopolysiloxane ammonium component is placed in a solvent that is inert toward polymerization or coupling reaction. Particularly suitable solvents are water or water-ethanol, water-acetone and like water-polar co-solvent systems. Upon removal of the solvent, the intercalated particulate concentrates are obtained. In the solvent-free process, a high shear blender is usually required to conduct the intercalation reaction. The inorganic-organic nanocomposite may be in a suspension, gel, paste or solid forms.

A specific class of ammonium-containing organopolysiloxanes are those described in U.S. Pat. No. 5,130,396 the entire contents of which are incorporated by reference herein and can be prepared from known materials including those which are commercially available.

The ammonium-containing organopolysiloxanes of U.S. Pat. No. 5,130,396 is represented by the general formula: 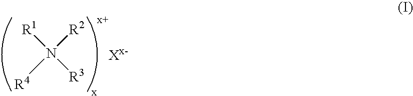
in which R¹ and R² are identical or different and represent a group of the formula: 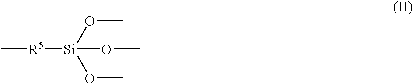
in which the nitrogen atoms in (I) are connected to the silicon atoms in (II) via the R⁵ groups and R⁵ represents an alkylene group with 1 to 10 carbon atoms, a cycloalkylene group with 5 to 8 atoms or a unit of the general formula: 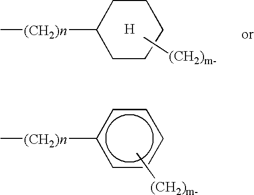
in which n is a number from 1 to 6 and indicates the number of methylene groups in nitrogen position and m is a number from 0 to 6 and the free valences of the oxygen atoms bound to the silicon atom are saturated as in silica skeletons by silicon atoms of other groups of formula (II) and/or with the metal atoms of one or more of the cross-linking binding links 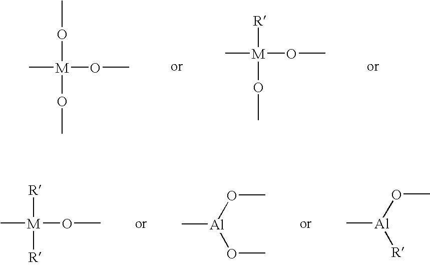
in which M is a silicon, titanium or zirconium atom and R′ a linear or branched alkyl group with 1 to 5 carbon atoms and the ratio of the silicon atoms of the groups of formula (II) to the metal atoms in the binding links is 1:0 to and in which R³ is equal to R¹ or R², or hydrogen, or a linear or branched alkyl group of 1 to 20 carbon atoms, a cycloalkyl group of 5 to 8 carbon atoms or is the benzyl group, and R⁴ is equal to hydrogen, or a linear or branched alkyl group with 1 to 20 carbon atoms or is a cycloalkyl, benzyl, alkyl, propargyl, chloroethyl, hydroxyethyl, or chloropropyl group consisting of 5 to 8 carbon atoms and X is an anion with the valence of x equal to 1 to 3 and selected from the group of halogenide, hypochlorite, sulfate, hydrogen sulfate, nitrite, nitrate, phosphate, dihydrogen phosphate, hydrogen phosphate, carbonate, hydrogen carbonate, hydroxide, chlorate, perchlorate, chromate, dichromate, cyanide, cyanate, rhodanide, sulfide, hydrogen sulfide, selenide, telluride, borate, metaborate, azide, tetrafluoroborate, tetraphenylborate, hexafluorophosphate, formate, acetate, propionate, oxalate, trifluoroacetate, trichloroacetate or benzoate.

The ammonium-containing organopolysiloxane compounds described herein are macroscopically spherical shaped particles with a diameter of 0.01 to 3.0 mm, a specific surface area of 0 to 1000 m²/g, a specific pore volume of 0 to 5.0 ml/g, a bulk density of 5.0 to 1000 g/l as well as a dry substance basis in relation to volume of 50 to 750 g/l.

One method of preparing an ammonium-containing organopolysiloxane involves reacting a primary, secondary, or tertiary aminosilane possessing at least one hydrolysable alkoxy group, with water, optionally in the presence of a catalyst, to achieve hydrolysis and subsequent condensation of the silane and produce amine-terminated organopolysilane which is thereafter quaternized with a suitable quarternizing reactant such as a mineral acid and/or alkyl halide to provide the ammonium-containing organopolysiloxane. A method of this type is described in aforesaid U.S. Pat. No. 5,130,396. In this connection, U.S. Pat. No. 6,730,766, the entire contents of which are incorporated by reference herein, describes processes for the manufacture of quaternized polysiloxane by the reaction of epoxy-functional polysiloxane.

In a variation of this method, the primary, secondary or tertiary aminosilane possessing hydrolysable alkoxy group(s) is quarternized prior to the hydrolysis condensation reactions providing the organopolysiloxane. For example, ammonium-containing N-trimethoxysilylpropyl-N,N, N-trimethylammonium chloride, N-trimethoxysilylpropyl-N,N, N-tri-n-butylammonium chloride, and commercially available ammonium-containing trialkoxysilane octadecyldimethyl(3-trimethyloxysilylpropyl) ammonium chloride (available from Gelest, Inc.) following their hydrolysis/condensation will provide ammonium-containing organopolysiloxane for use herein.

Other suitable tertiary aminosilane useful for preparing ammonium-containing organopolysiloxane include tris(triethoxysilylpropyl)amine, tris(trimethoxysilylpropyl)amine, tris(diethoxymethylsilylpropyl)amine, tris(tripropoxysilylpropyl)amine, tris(ethoxydimethylsilylpropyl)amine, tris(triethoxyphenylsilylpropyl)amine, and the like.

Still another method for preparing the ammonium-containing organopolysiloxane calls for quarternizing a primary, secondary, or tertiary amine-containing organopolysiloxane with quaternizing reactant. Useful amine-containing organopolysiloxanes include those of the general formula: 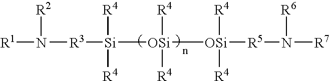
wherein R¹, R², R⁶, and R⁷ each independently is H, hydrocarbyl of up to 30 carbon atoms, e.g., alkyl, cycloalkyl, aryl, alkaryl, aralkyl, etc., or R¹ and R² together or R⁶ and R⁷ together form a divalent bridging group of up to 12 carbon atoms, R³ and R⁵ each independently is a divalent hydrocarbon bridging group of up to 30 carbon atoms, optionally containing one or more oxygen and/or nitrogen atoms in the chain, e.g., straight or branched chain alkylene of from 1 to 8 carbons such as —CH₂—, —CH₂ CH₂—, —CH₂CH₂CH₂—, —CH₂—C(CH₃)—CH₂—, —CH₂CH₂CH₂ CH₂—, etc., each R⁴ independently is an alkl group, and n is from 1 to 20 and advantageously is from 6 to 12.

These and similar amine-containing organopolysiloxanes can be obtained by known and conventional procedures e.g., by reacting an olefinic amine such as allyamine with a polydiorganosiloxane possessing Si—H bonds in the presence of a hydrosilation catalyst, such as, a platinum-containing hydrosilation catalyst as described in U.S. Pat. No. 5,026,890, the entire contents of which are incorporated by reference herein.

Specific amine-containing organopolysiloxanes that are useful for preparing the ammonium-containing organopolysiloxanes herein include the commercial mixture of

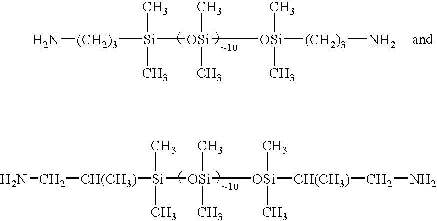

Optionally, the curable composition herein can also contain at least one solid polymer (e) having a permeability to gas that is less than the permeability of the crosslinked diorganopolysiloxane. Suitable polymers include polyethylenes such as low density polyethylene (LDPE), very low density polyethylene (VLDPE), linear low density polyethylene (LLDPE) and high density polyethylene (HDPE); polypropylene (PP), polyisobutylene (PIB), polyvinyl acetate(PVAc), polyvinyl alcohol (PVoH), polystyrene, polycarbonate, polyester, such as, polyethylene terephthalate (PET), polybutylene terephthalate (PBT), polyethylene napthalate (PEN), glycol-modified polyethylene terephthalate (PETG); polyvinylchloride (PVC), polyvinylidene chloride, polyvinylidene floride, thermoplastic polyurethane (TPU), acrylonitrile butadiene styrene (ABS), polymethylmethacrylate (PMMA), polyvinyl fluoride (PVF), Polyamides (nylons), polymethylpentene, polyimide (PI), polyetherimide (PEI), polether ether ketone (PEEK), polysulfone, polyether sulfone, ethylene chlorotrifluoroethylene, polytetrafluoroethylene (PTFE), cellulose acetate, cellulose acetate butyrate, plasticized polyvinyl chloride, ionomers (Surtyn), polyphenylene sulfide (PPS), styrene-maleic anhydride, modified polyphenylene oxide (PPO), and the like and mixture thereof.

The optional polymer(s) can also be elastomeric in nature, examples include, but are not limited to ethylene-propylene rubber (EPDM), polybutadiene, polychloroprene, polyisoprene, polyurethane (TPU), styrene-butadiene-styrene (SBS), styrene-ethylene-butadiene-styrene (SEEBS), polymethylphenyl siloxane (PMPS), and the like.

These optional polymers can be blended either alone or in combinations or in the form of coplymers, e.g. polycarbonate-ABS blends, polycarbonate polyester blends, grafted polymers such as, silane grafted polyethylenes, and silane grafted polyurethanes.

In one embodiment of the present invention, the curable composition contains a polymer selected from the group consisting of low density polyethylene (LDPE), very low density polyethylene (VLDPE), linear low density polyethylene (LLDPE), high density polyethylene (HDPE), and mixtures thereof. In another embodiment of the invention, the curable composition has a polymer selected from the group consisting of low density polyethylene (LDPE), very low density polyethylene (VLDPE), linear low density polyethylene (LLDPE), and mixture thereof. In yet another embodiment of the present invention, the optional polymer is a linear low density polyethylene (LLDPE).

The curable sealant composition can contain one or more other fillers in addition to inorganic-organic nanocomposite component (d). Suitable additional fillers for use herein include precipitated and colloidal calcium carbonates which have been treated with compounds such as stearic acid or stearate ester; reinforcing silicas such as fumed silicas, precipitated silicas, silica gels and hydrophobized silicas and silica gels; crushed and ground quartz, alumina, aluminum hydroxide, titanium hydroxide, diatomaceous earth, iron oxide, carbon black, graphite, mica, talc, and the like, and mixtures thereof.

The curable sealant composition of the present invention can also include one or more alkoxysilanes as adhesion promoters. Useful adhesion promoters include N-2-aminoethyl-3-aminopropyltriethoxysilane, γ-aminopropyltriethoxysilane, γ-aminopropyltrimethoxysilane, aminopropyltrimethoxysilane, bis-γ-trimethoxysilypropyl)amine, N-phenyl-γ-aminopropyltrimethoxysilane, triaminofunctionaltrimethoxysilane, γ-aminopropylmethyldiethoxysilane, γ-aminopropylmethyldiethoxysilane, methacryloxypropyltrimethoxysilane, methylaminopropyltrimethoxysilane, γ-glycidoxypropylethyldimethoxysilane, γ-glycidoxypropyltrimethoxysilane, γ-glycidoxyethyltrimethoxysilane, β-(3,4-epoxycyclohexyl)propyltrimethoxysilane, β-(3,4-epoxycyclohexyl)ethylmethyldimethoxysilane, isocyanatopropyltriethoxysilane, isocyanatopropylmethyldimethoxysilane, β-cyanoethyltrimethoxysilane, γ-acryloxypropyltrimethoxysilane, γ-methacryloxypropylmethyldimethoxysilane, 4-amino-3,3,-dimethylbutyltrimethoxysilane, and N-ethyl-3-trimethoxysilyl-2-methylpropanamine, and the like. In one embodiment, the adhesion promoter can be a combination of n-2-aminoethyl-3-aminopropyltrimethoxysilane and 1,3,5-tris(trimethoxysilylpropyl)isocyanurate.

The compositions of the present invention can also include one or more non-ionic surfactants such as polyethylene glycol, polypropylene glycol, ethoxylated castor oil, oleic acid ethoxylate, alkylphenol ethoxylates, copolymers of ethylene oxide (EO) and propylene oxide (PO) and copolymers of silicones and polyethers (silicone polyether copolymers), copolymers of silicones and copolymers of ethylene oxide and propylene oxide and mixtures thereof.

The curable sealant compositions of the present invention can include still other ingredients that are conventionally employed in RTC silicone-containing compositions such as colorants, pigments, plasticizers, antioxidants, UV stabilizers, biocides, etc., in known and conventional amounts provided they do not interfere with the properties desired for the cured compositions.

The amounts of silanol-terminated diorganopolysiloxane(s), crosslinker(s), crosslinking catalyst(s), inorganic-organic nanocomposite(s), optional solid polymers(s) of lower gas permeability than the crosslinked diorganopolysiloxane(s), optional filler(s) other than inorganic-organic nanocomposite, optional adhesion promoter(s) and optional ionic surfactant(s) can vary widely and, advantageously, can be selected from among the ranges indicated in the following table. The curable compositions herein contain inorganic-organic nanocomposite in an amount, of course, that enhances its gas barrier properties.

TABLE 1
Ranges of Amounts (Weight Percent) of Components of the
Curable Composition of the Invention

| Components of the | First | Second | Third |
|---|---|---|---|
| Curable Composition | Range | Range | Range |
| Silanol-terminated | 50-99 | 70-99 | 80-85 |
| Diorganopolysiloxane(s) | | | |
| Crosslinker(s) | 0.1-10 | 0.3-5 | 0.5-1.5 |
| Crosslinking Catalyst(s) | 0.001-1 | 0.003-0.5 | 0.005-0.2 |
| Inorganic-organic | 0.1-50 | 10-30 | 15-20 |
| Nanocomposite(s) | | | |
| Solid Polymer(s) of Lower | 0-50 | 5-40 | 10-35 |
| Gas Permeability than | | | |
| Crosslinked Dioganopoly- | | | |
| Siloxane(s) | | | |
| Filler(s) other than | 0-90 | 5-60 | 10-40 |
| Inorganic-organic | | | |
| Nanocomposite | | | |
| Silane Adhesion | 0-20 | 0.1-10 | 0.5-2 |
| Promoter(s) | | | |
| Ionic Surfactant(s) | 0-10 | 0.1-5 | 0.5-0.75 |

The curable compositions herein can be obtained by procedures that are well known in the art, e.g., melt blending, extrusion blending, solution blending, dry mixing, blending in a Banbury mixer, etc., in the presence of moisture to provide a substantially homogeneous mixture.

Preferably, the methods of blending the diorganopolysiloxane polymers with polymers may be accomplished by contacting the components in a tumbler or other physical blending means, followed by melt blending in an extruder. Alternatively, the components can be melt blended directly in an extruder, Brabender or any other melt blending means.

The invention is illustrated by the following non-limiting examples.

### COMPARATIVE EXAMPLE 1 AND EXAMPLES 1-2

Inorganic-organic nanocomposite was prepared by first placing 10 g of amino propyl terminated siloxane (“GAP 10,” siloxane length of 10, from GE Silicones, Waterford, USA) in a 100 ml single-necked round bottomed flask and adding 4 ml of methanol available from Merck. 2.2 ml of concentrated HCl was added very slowly with stirring. The stirring was continued for 10 minutes. 900 ml of water was added to a 2000 ml three-necked round-bottomed flask fitted with condenser and overhead mechanical stirrer. 18 g of Cloisite Na⁺ (natural montmorillonite available from Southern Clay Products) clay was added to the water very slowly with stirring (stirring rate approximately 250 rpm). The ammonium chloride solution (prepared above) was then added very slowly to the clay-water mixture. The mixture was stirred for 1 hour and let stand overnight. The mixture was filtered through a Buckner funnel and the solid obtained was slurried with 800 ml of methanol, stirred for 20 minutes, and then the mixture was filtered. The solid was dried in oven at 80° C. for approximately 50 hours.

To provide a 2.5 weight percent nanocomposite, 224.25 g of OMCTS (octamethylcyclotetrasiloxane) and 5.75 g of GAP 10 modified clay (inorganic-organic nanocomposite prepared above) were introduced into a three-necked round bottom flask fitted with overhead stirrer and condenser. The mixture was stirred at 250 rpm for 6 hours at ambient temperature. The temperature was increased to 175 C.° while stirring continued. 0.3 g of CsOH in 1 ml of water was added in the reaction vessel through septum. After 15 minutes, polymerization of OMCTS began and 0.5 ml of water was added with an additional 0.5 ml of water being added after 5 minutes. Heating and stirring were continued for 1 hour after which 0.1 ml of phosphoric acid was added for neutralization. The pH of the reaction mixture was determined after 30 minutes. Stirring and heating were continued for another 30 minutes and the pH of the reaction mixture was again determined to assure complete neutralization. Distillation of cyclics was carried out at 175 C.° and the mixture was thereafter cooled to room temperature.

The same procedure was followed with 5 weight percent of GAP 10 modified clay.

In-situ polymerization procedures were followed with 2.5 wt % and 5 wt % (see Table 1) GAP 10 modified clays (prepared above). The in-situ polymers with different amounts of clay were then used to make cured sheets as follows: In-situ silanol-terminated polydimethylsiloxanes (PDMS), (Silanol 5000, a silanol-terminated polydimethylsiloxane of 5000 cs nominal and Silanol 50,000, a silanol-terminated polydimethylsiloxane of 50,000 cs nominal, both available from Gelest, Inc.) GAP 10 modified clay formulations were mixed with NPS (n-propyl silicate, available from Gelest, Inc.) crosslinker and solubilized DBTO (solubilized dibutyl tin oxide, available from GE silicones, Waterford, USA) catalyst using a hand blender for 5-7 min with air bubbles being removed by vacuum. The mixture was then poured into a Teflon sheet-forming mold and maintained for 24 hours under ambient conditions (25° C. and 50% humidity). The partially cured sheets were removed from the mold after 24 hours and maintained at ambient temperature for seven days for complete curing.

TABLE 1

| | | wt % | wt % |
|---|---|---|---|
| | grams | NPS | DBTO |
| Comparative Example 1 | 50 | 2 | 1.2 |
| Example 1: In-situ silanol with 2.5 | 50 | 2 | 1.2 |
| wt % of modified clay | | | |
| Example 2: In-situ silanol with 5 wt % | 50 | 2 | 1.2 |
| of modified clay | | | |

The Argon permeability was measured using a gas permeability set-up. Argon permeability was measured using a gas permeability set-up as in the previous examples. The measurements were based on the variable-volume method at 100 psi pressure and at a temperature of 25° C. Measurements were repeated under identical conditions 2-3 times in order to assure their reproducibility.

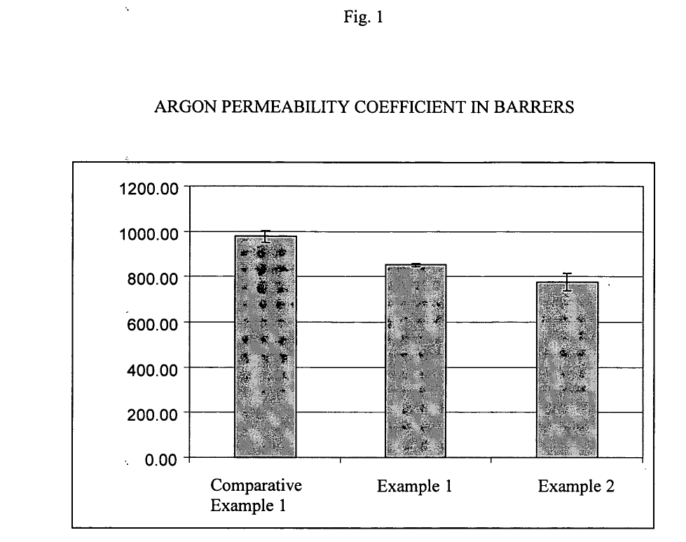

The permeability data for Comparative Example 1 and Examples 1 and 2 are graphically presented in FIG. 1.

### COMPARATIVE EXAMPLE 2 AND EXAMPLE 3

Example 3 (see Table 2) was prepared by mixing 45 grams of PDMS and 5 grams of GAP 10 modified clay (prepared above) and similar in-situ polymerization procedures were followed by mixing with 2 wt % NPS, and 1.2 wt % DBTO, using a hand blender for 5-7 minutes with air bubbles being removed by vacuum. Each blend was poured into a Teflon sheet-forming mold and maintained for 24 hours under ambient conditions (25° C. and 50% humidity) to partially cure the PDMS components. The partially cured sheets were removed from the mold after 24 hours and maintained at ambient temperature for seven days for complete curing.

TABLE 2

| | | wt % | wt % |
|---|---|---|---|
| | grams | NPS | DBTO |
| Comparative Example 2: Silanol mixture | 50 | 2 | 1.2 |
| Example 3: In-situ silanol with 5 wt % of | 50 | 2 | 1.2 |
| modified clay | | | |

The Argon permeability was measured using a gas permeability set-up as in the previous examples. Argon permeability was measured using a gas permeability set-up as in the previous examples. The measurements were based on the variable-volume method at 100 psi pressure and at a temperature of 25° C. Measurements were repeated under identical conditions 2-3 times in order to assure their reproducibility.

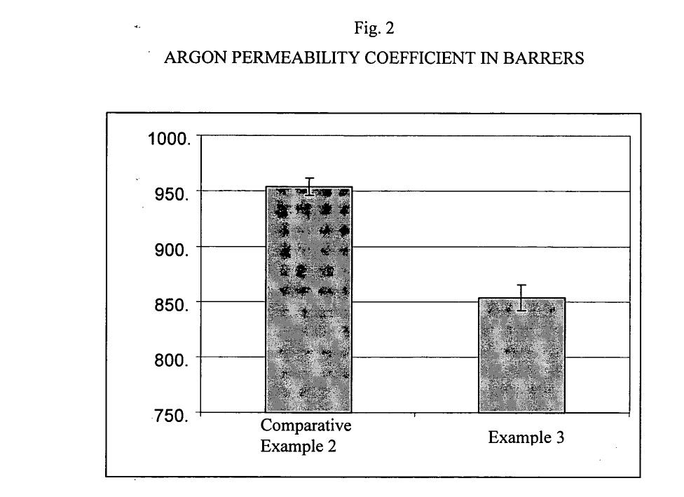

The permeability data for Comparative Example 2 and Example 3 are graphically presented in FIG. 2.

### COMPARATIVE EXAMPLE 3 AND EXAMPLES 4 AND 5

The inorganic-organic nanocomposite of Examples 4 and 5 was prepared by introducing 15 grams of octadecyldimethyl(3-trimethoxysilyl propyl)) ammonium chloride (available from Gelest, Inc.) into a 100 ml beaker and slowly adding 50 ml of methanol (available from Merck). 30 grams of Cloisite 15A (“C-15A,” a montmorillonite clay modified with 125 milliequivalants of dimethyl dehydrogenated tallow ammonium chloride per 100 g of clay available from Southern Clay Products) clay was added very slowly to a 5 liter beaker containing a water:methanol solution (1:3 ratio, 3.5 L) and equipped with an overhead mechanical stirrer which stirred the mixture at a rate of approximately 400 rpm. The stirring continued for 12 hours. The octadecyldimethyl(3-trimethoxysilyl propyl)) ammonium chloride (prepared above) was then added very slowly. The mixture was stirred for 3 hours. Thereafter, the mixture was filtered through a Buckner funnel and the solid obtained was slurried with a water: methanol (1:3) solution several times before being filtered again. The solid was dried in oven at 80 C.° for approximately 50 hours.

The above-indicated blends were then used to make cured sheets as follows: PDMS—silypropyl modified clay formulations were mixed with NPS and DBTO, as listed in Table 3, using a hand blender for 5-7 minutes with air bubbles being removed by vacuum. Each blend was poured into a Teflon sheet-forming mold and maintained for 24 hours under ambient conditions (25° C. and 50% humidity) to partially cure the PDMS components. The partially cured sheets were removed from the mold after 24 hours and maintained at ambient temperature for seven days for complete curing.

TABLE 3

| | | wt % | wt % |
|---|---|---|---|
| | grams | NPS | DBTO |
| Comparative Example 3: Silanol | 50 | 2 | 1.2 |
| mixture | | | |
| Example 4: Silanol mixture with 5 phr | 50 | 2 | 1.2 |
| of silylpropyl modified clay | | | |
| Example 5: Silanol mixture with | 50 | 2 | 1.2 |
| 10 phr of silylpropyl modified clay | | | |

The Argon permeability was measured using a gas permeability set-up as in the previous examples. Argon permeability was measured using a gas permeability set-up as in the previous examples. The measurements were based on the variable-volume method at 100 psi pressure and at a temperature of 25° C. Measurements were repeated under identical conditions 2-3 times in order to assure their reproducibility.

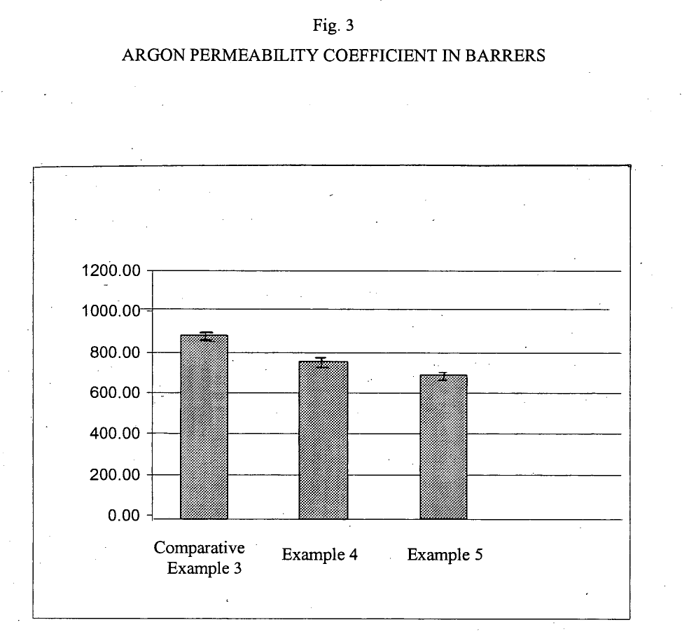

The permeability data for Comparative Example 3 and Examples 4 and 5 are graphically presented in FIG. 3.

The permeability data are graphically presented in FIGS. 1, 2 and 3. As shown in the data, argon permeability in the case of the cured sealant compositions of the invention (Examples 1 and 2 of FIG. 1, Example 3 of FIG. 2 and Examples 4 and 5 of FIG. 3) was significantly less than that of cured sealant compositions outside the scope of the invention (Comparative Examples 1-3 of FIGS. 1-3, respectively). In all, while the argon permeability coefficients of the sealant compositions of Comparative Examples 1, 2 and 3 exceed 950 barrers, those of Examples 1-3, 4 and 5 illustrative of sealant compositions of this invention did not exceed 875 barrers and in some cases, were well below this level of argon permeability coefficient (see, in particular, examples 2, 4 and 5).

While the preferred embodiment of the present invention has been illustrated and described in detail, various modifications of, for example, components, materials and parameters, will become apparent to those skilled in the art, and it is intended to cover in the appended claims all such modifications and changes which come within the scope of this invention.

What is claimed is:

1. A curable sealant composition comprising:
a) at least one silanol-terminated diorganopolysiloxane;
b) at least one crosslinker for the silanol-terminated diorganopolysiloxane(s);
c) at least one catalyst for the crosslinking reaction;
d) a gas barrier enhancing amount of at least one inorganic-organic nanocomposite; and, optionally,
e) at least one solid polymer having a permeability to gas that is less than the permeability of the crosslinked diorganopolysiloxane(s).

2. The composition of claim 1 wherein silanol-terminated diorganopolysiloxane (a) has the general formula:
MₐD_{b}D′_{c}
wherein “a” is 2, and “b” is equal to or greater than 1 and “c” is zero or positive; M is
(HO)_{3-x-y}R¹ₓR²_{y}SiO_{1/2}
wherein “x” is 0, 1 or 2 and “y” is either 0 or 1, subject to the limitation that x+y is less than or is equal to 2, R¹ and R² each independently is a monovalent hydrocarbon group up to 60 carbon atoms; D is
R³R⁴SiO_{1/2};
wherein R³ and R⁴ each independently is a monovalent hydrocarbon group up to 60 carbon atoms; and D′ is
R⁵R⁶SiO_{2/2}
wherein R⁵ and R⁶ each independently is a monovalent hydrocarbon group up to 60 carbon atoms.

3. The composition of claim 1 wherein crosslinker (b) is an alkylsilicate having the formula:
(R¹⁴O)(R¹⁵O)(R¹⁶O)(R¹⁷O)Si
where R¹⁴, R¹⁵, R¹⁶ and R¹⁷ are chosen independently from monovalent C₁ to C₆₀ hydrocarbon radicals.

4. The composition of claim 1 wherein catalyst (c) is a tin catalyst.

5. The composition of claim 4 wherein the tin catalyst is selected from the group consisting of dibutyltindilaurate, dibutyltindiacetate, dibutyltindimethoxide, tinoctoate, isobutyltintriceroate, dibutyltinoxide, dibutyltin bis-diisooctylphthalate, bis-tripropoxysilyl dioctyltin, dibutyltin bis-acetylacetone, silylated dibutyltin dioxide, carbomethoxyphenyl tin tris-uberate, isobutyltin triceroate, dimethyltin dibutyrate, dimethyltin di-neodecanoate, triethyltin tartarate, dibutyltin dibenzoate, tin oleate, tin naphthenate, butyltintri-2-ethylhexylhexoate, tinbutyrate, diorganotin bis P-diketonates and mixtures thereof.

6. The composition of claim 1 wherein the inorganic-organic nanocomposite comprises at least one inorganic component which is a layered inorganic nanoparticulate and at least one organic component which is a quaternary ammonium organopolysiloxane.

7. The inorganic-organic nanocomposite of claim 6 wherein the layered inorganic nanoparticulate possess exchangeable cation which is at least one member selected from the group of Na⁺, Ca²⁺, Al³⁺, Fe²⁺, Fe³⁺, Mg²⁺, and mixtures thereof.

8. The inorganic-organic nanocomposite of claim 6 wherein the layered nanoparticulate is at least one member selected from the group consisting of montmorillonite, sodium montmorillonite, calcium montmorillonite, magnesium montmorillonite, nontronite, beidellite, volkonskoite, laponite, hectorite, saponite, sauconite, magadite, kenyaite, sobockite, svindordite, stevensite, vermiculite, halloysite, aluminate oxides, hydrotalcite, illite, rectorite, tarosovite, ledikitekaolinite and, mixtures thereof.

9. The inorganic-organic nanocomposite of claim 6 wherein the quaternary ammonium organopolysiloxane is at least one ammonium-containing diorganopolysiloxane having the formula:
MₐD_{b}D′_{c}
wherein “a” is 2, and “b” is equal to or greater than 1 and “c” is zero or positive; M is
[R³_{z}NR⁴]_{3-x-y}R¹ₓR²_{y}SiO_{1/2}
wherein “x” is 0, 1 or 2 and “y” is either 0 or 1, subject to the limitation that x+y is less than or equal to 2, “z” is 2, R¹ and R² each independently is a monovalent hydrocarbon group up to 60 carbons; R³ is selected from the group consisting of H and a monovalent hydrocarbon group up to 60 carbons; R⁴ is a monovalent hydrocarbon group up to 60 carbons; D is
R⁵R⁶SiO_{1/2}
where R⁵ and R⁶ each independently is a monovalent hydrocarbon group up to 60 carbon atoms; and D′ is
R⁷R⁸SiO_{2/2}
where R⁷ and R⁸ each independently is a monovalent hydrocarbon group containing amine with the general formula:
[R⁹ₐNR¹⁰]
wherein “a” is 2, R⁹ is selected from the group consisting of H and a monovalent hydrocarbon group up to 60 carbons; R¹⁰ is a monovalent hydrocarbon group up to 60 carbons.

10. The inorganic-organic nanocomposite of claim 9 wherein the quaternary ammonium group is represented by the formula R⁶, R⁷, R⁸N⁺X⁻ wherein at least one R⁶, R⁷ and R⁸ is an alkoxy silane up to 60 carbon atoms and the remaining are an alkyl or alkenyl group of up to 60 carbon atoms and X is an anion.

11. The composition of claim 1 wherein solid polymer (e) is selected from the group consisting of low density polyethylene, very low density polyethylene, linear low density polyethylene, high density polyethylene, polypropylene, polyisobutylene, polyvinyl acetate, polyvinyl alcohol, polystyrene, polycarbonate, polyester, such as, polyethylene terephthalate, polybutylene terephthalate, polyethylene napthalate, glycol-modified polyethylene terephthalate, polyvinylchloride, polyvinylidene chloride, polyvinylidene fluoride, thermoplastic polyurethane, acrylonitrile butadiene styrene, polymethylmethacrylate, polyvinyl fluoride, polyamides, polymethylpentene, polyimide, polyetherimide, polether ether ketone, polysulfone, polyether sulfone, ethylene chlorotrifluoroethylene, polytetrafluoroethylene, cellulose acetate, cellulose acetate butyrate, plasticized polyvinyl chloride, ionomers, polyphenylene sulfide, styrene-maleic anhydride, modified polyphenylene oxide, ethylene-propylene rubber, polybutadiene, polychloroprene, polyisoprene, polyurethane, styrene-butadiene-styrene, styrene-ethylene-butadiene-styrene, polymethylphenyl siloxane and mixtures thereof.

12. The composition of claim 1 which further comprises at least one optional component selected from the group consisting of adhesion promoter, surfactant, colorant, pigment, plasticizer, filler other than inorganic-organic nanocomposite, antioxidant, UV stabilizer, and biocide.

13. The composition of claim 12 wherein the adhesion promoter is selected from the group consisting of n-2-aminoethyl-3-aminopropyltrimethoxysilane, 1,3,5-tris(trimethoxysilylpropyl)isocyanurate, γ-aminopropyltriethoxysilane, γ-aminopropyltrimethoxysilane, aminopropyltrimethoxysilane, bis-γ-trimethoxysilypropyl)amine, N-Phenyl-γ-aminopropyltrimethoxysilane, triaminofunctionaltrimethoxysilane, γ-aminopropylmethyldiethoxysilane, γ-aminopropylmethyldiethoxysilane, methacryloxypropyltrimethoxysilane, methylaminopropyltrimethoxysilane, γ-glycidoxypropylethyldimethoxysilane, γ-glycidoxypropyltrimethoxysilane, γ-glycidoxyethyltrimethoxysilane, β-(3,4-epoxycyclohexyl)propyltrimethoxysilane, β-(3,4-epoxycyclohexyl)ethylmethyldimethoxysilane, isocyanatopropyltriethoxysilane, isocyanatopropylmethyldimethoxysilane, β-cyanoethyltrimethoxysilane, γ-acryloxypropyltrimethoxysilane, γ-methacryloxypropylmethyldimethoxysilane, 4-amino-3,3,-dimethylbutyltrimethoxysilane, n-ethyl-3-trimethoxysilyl-2-methylpropanamine, and mixtures thereof.

14. The composition of claim 12 wherein the surfactant is a nonionic surfactant selected from the group consisting of polyethylene glycol, polypropylene glycol, ethoxylated castor oil, oleic acid ethoxylate, alkylphenol ethoxylates, copolymers of ethylene oxide and propylene oxide and copolymers of silicones and polyethers, copolymers of silicones and copolymers of ethylene oxide and propylene oxide and mixtures thereof.

15. The composition of claim 14 wherein the non-ionic surfactant is selected from the group consisting of copolymers of ethylene oxide and propylene oxide, copolymers of silicones and polyethers, copolymers of silicones and copolymers of ethylene oxide and propylene oxide and mixtures thereof.

16. The composition of claim 12 wherein the filler other than the inorganic-organic nanocomposite is selected from the group consisting of calcium carbonate, precipitated calcium carbonate, colloidal calcium carbonate, calcium carbonate treated with compounds stearate or stearic acid, fumed silica, precipitated silica, silica gels, hydrophobized silicas, hydrophilic silica gels, crushed quartz, ground quartz, alumina, aluminum hydroxide, titanium hydroxide, clay, kaolin, bentonite montmorillonite, diatomaceous earth, iron oxide, carbon black and graphite, mica, talc, and mixtures thereof.

17. The curable composition of claim 1 wherein:
silanol-terminated diorganopolysiloxane (a) has the general formula:
MₐD_{b}D′_{c}
wherein “a” is 2, and “b” is equal to or greater than 1 and “c” is zero or positive; M is
(HO)_{3-x-y}R¹ₓR²_{y}SiO_{1/2}
wherein “x” is 0, 1 or 2 and “y” is either 0 or 1, subject to the limitation that x+y is less than or is equal to 2, R¹ and R² each independently is a monovalent hydrocarbon group up to 60 carbon atoms; D is
R³R⁴SiO_{1/2};
wherein R³ and R⁴ each independently is a monovalent hydrocarbon group up to 60 carbon atoms; and D′ is
R⁵R⁶SiO_{2/2}
wherein R⁵ and R⁶ each independently is a monovalent hydrocarbon group up to 60 carbon atoms;
crosslinker (b) is an alkylsilicate having the formula:
(R¹⁴O)(R¹⁵O)(R¹⁶O)(R₁₇O)Si
where R¹⁴, R¹⁵, R¹⁶ and R¹⁷ are chosen independently from monovalent hydrocarbon radicals of up to 60 carbon atoms;
catalyst (c) is a tin catalyst; and,
inorganic nanoparticulate portion of inorganic-organic nanocomposite (d) is selected from the group consisting of montmorillonite, sodium montmorillonite, calcium montmorillonite, magnesium montmorillonite, nontronite, beidellite, volkonskoite, laponite, hectorite, saponite, sauconite, magadite, kenyaite, sobockite, svindordite, stevensite, vermiculite, halloysite, aluminate oxides, hydrotalcite, illite, rectorite, tarosovite, ledikite, kaolinite and, mixtures thereof, the organic portion of inorganic-organic nanocomposite (d) being at least one quarternary ammonium compound R⁶, R⁷, R⁸N⁺ X⁻ wherein at least one R⁶, R⁷ and R⁸ is an alkoxy silane up to 60 carbon atoms and the remaining are an alkyl or alkenyl group of up to 60 carbon atoms and X is an anion.

18. The cured composition of claim 1.

19. The cured composition of claim 11.

20. The cured composition of claim 12.

21. The cured composition of claim 17.

22. The composition of claim 18 exhibiting an argon permeability coefficient of not greater than about 900 barrers.

23. The composition of claim 19 exhibiting an argon permeability coefficient of not greater than about 900 barrers.

24. The composition of claim 20 exhibiting an argon permeability coefficient of not greater than about 900 barrers.

25. The composition of claim 21 exhibiting an argon permeability coefficient of not greater than about 900 barrers.
